(19) United States
(12) Patent Application Publication
(10) Pub. No.: US 2002/0189800 A1
(43) Pub. Date: Dec. 19, 2002

(54) Cooling system for a motor vehicle

(76) Inventors: Reiner Hohl, Stuttgart (DE); Manfred Schmitt, Heppenheim (DE)

Correspondence Address: Striker Striker & Stenby, 103 East Neck Road, Huntington, NY, 11743, US

(21) Appl. No.: 10/203,490

(22) PCT Filed: Nov. 21, 2001
(86) PCT No.: PCT/DE01/04356

(30) Foreign Application Priority Data
Dec. 23, 2000 (DE) 100 65 003.1

(51) Int. Cl. F28F 1/00; G05D 23/00

(52) U.S. Cl. 165/287; 165/41

(57) ABSTRACT

The invention concerns a cooling system for a motor vehicle having at least one coolant pump (30) that is provided in order to circulate coolant in the cooling system, and having a main radiator (10) that has at least one main radiator inlet (11) and at least one main radiator outlet (12), whereby the main radiator inlet (11) is interconnected at least part of the time with a coolant outlet (24) of an internal combustion engine (20) to be cooled, while the main radiator outlet (12) is interconnected with a coolant inlet (23) of the internal combustion engine (20).

It is provided, according to the invention, that at least a first assembly (60, 80) to be cooled is connected in parallel with the internal combustion engine and/or the main radiator (10).

The present invention concerns a cooling system for a motor vehicle having at least one coolant pump that is provided in order to circulate coolant in the cooling system, and having a main radiator that has at least one main radiator inlet and at least one main radiator outlet, whereby the main radiator inlet is interconnected at least part of the time with a coolant outlet of an internal combustion engine to be cooled, while the main radiator outlet is interconnected with a coolant inlet of the internal combustion engine.

### BACKGROUND OF THE INVENTION

The need for cooling in the case of internal combustion engines generally results from the fact that the surfaces having contact with hot gasses and their lubrication inside the cylinder can only withstand the temperatures reached within certain limits without incurring damage. Although temperatures of over 2000° C. are reached during ignition, cool-down periods exist between two firings that are caused, for example, by purge air, expansion processes or heat withdrawal when fuels evaporate, so that, overall, a substantially lower mean temperature results. Parts such as spark plugs, nozzles, prechambers, exhaust valves, piston heads, etcetera, must withstand particularly high mean temperatures. For this reason, parts of this nature are produced out of materials having high thermal resistance, and they are provided with good heat dissipation and special cooling mechanisms. Cooling systems are therefore used to dissipate heat, in which said cooling systems a coolant flows through the coolant passages that surround at least the cylinder and the cylinder head, in order to subsequently dissipate the heat via a radiator at least partially into the surrounding air. FIG. 1 is a schematic illustration of a generic cooling system according to the related art. A radiator 10 has a radiator inlet 11 and a radiator outlet 12. An internal combustion engine 20 to be cooled has a coolant inlet 23 and a coolant outlet 24, whereby the coolant outlet is interconnected with the radiator inlet 11 via lines 101, 102 and a mixing valve 50. A coolant pump 30 is provided for circulating the coolant, the pressure side 34 of which is interconnected via a line 105 with the coolant inlet 23 of the internal combustion engine 20. The suction side 33 of the coolant pump 30 is interconnected via lines 103, 104 with the radiator outlet 12 of the radiator 10. The coolant outlet 24 is capable of being interconnected with the suction side 33 of the coolant pump 30 via the mixing valve 50—which can be formed by a thermostat valve, for example—and a short-circuit line 106. Depending on the position of the mixing valve 50, the coolant emerging from the coolant outlet 24 is routed exclusively or partially to the radiator inlet 11, or it is routed via the short-circuit line 106 exclusively or partially to the suction side 33 of the coolant pump 30. The temperature of the coolant flowing through the internal combustion engine 20 can therefore be controlled with the aid of the mixing valve 50. Also shown in FIG. 1 is an expansion tank 40—which is of no further interest here—that is interconnected via a line 108 with the radiator inlet 11 and via a line 107 with the radiator outlet 12. Furthermore, a radiator fan 45 is provided that serves to direct an air stream at the radiator 10 so that the heat can be dissipated into the surrounding air in desired fashion via the radiator 10. The radiator fan 45 can be controlled in open-loop or closed-loop fashion, for example, as a function of the coolant temperature and/or a function of the vehicle speed and, therefore, the wind blast.

In the case of modern vehicles, various engine auxiliary assemblies—referred to hereinbelow also as assemblies or additional assemblies—are used that can comprise, for example, electrical machines, oil coolers, compressors and the like. In many cases it is necessary to cool such assemblies in the same way as the internal combustion engine itself. In the context of oil coolers and oil-water heat exchangers, in particular for automatic transmission fluid, it has therefore already been proposed to route a coolant drawn from a special section of the radiator to the oil-water heat exchanger before it is directed further toward the internal combustion engine. Moreover, it is standard, for example, to also connect the vehicle heater to the coolant circuit, whereby additional coolant pumps can be provided in the region of the heating system.

### ADVANTAGES OF THE INVENTION

Due to the fact that, in the case of the cooling system according to the invention, it is provided that at least a first assembly to be cooled is connected in parallel with the internal combustion engine and/or the main radiator, this assembly can be cooled without the need for additional coolant pumps and without coolant heated by the internal combustion engine being routed to the assembly or without coolant heated by the assembly being routed to the internal combustion engine.

According to a particularly preferred exemplary embodiment of the cooling system according to the invention, at least a second assembly to be cooled is furthermore provided that is connected to the cooling system via an additional radiator. By using an additional radiator, the second assembly to be cooled can be operated at a temperature that differs from the engine temperature level, e.g., at a markedly lower temperature.

It can be provided in the case of the cooling system according to the invention that the first assembly is an electrical machine, e.g., a generator, a starter, an (additional) drive motor or a starter-generator.

For example, if the second assembly is an electrical circuit, it can be necessary in many cases for this circuit to be operated in a markedly lower temperature range than the internal combustion engine. A particularly preferred exemplary embodiment of the cooling system according to the invention provides that the first assembly is an electrical machine and, in particular, a starter-generator, and that the second assembly is a power-electronics circuit associated with the starter-generator. Starter-generators combine the function of conventional starters and conventional dynamos or generators. Starter-generators are relatively strong heat sources and must therefore be cooled in many cases. Since they are capable of being operated frequently at temperatures similar to those of coolants used to cool the internal combustion engine, the parallel connection with the internal combustion engine and/or the main radiator is particularly advantageous. The power-electronics circuit that is generally associated necessarily with a starter-generator must be cooled in many cases as well in order to prevent damage to the components forming the circuit. The coolant temperatures typically used to cool internal combustion engines are usually too high for a power-electronics circuit of this nature, however. It is particularly advantageous, therefore, when the power-electronics circuit associated with the starter-generator is connected with the cooling system via an additional radiator, so that the power-electronics circuit can operate in a temperature range that is markedly lower than that of the coolant used to cool the internal combustion engine.

One exemplary embodiment of the cooling system according to the invention provides that a mixing valve is located between the main radiator inlet and the coolant outlet, which said mixing valve is interconnected via a short-circuit line with the suction side of the coolant pump in a manner known per se, and that the first assembly is connected between the mixing valve and the coolant outlet of the internal combustion engine. In the case of this exemplary embodiment, the heat given off by the first assembly can be used during the warm-up period of the internal combustion engine to warm it up more quickly. To accomplish this, the mixing valve blocks the supply of coolant to the main radiator entirely or partially so that coolant flowing back from the internal combustion engine as well as the coolant routed through the first assembly is routed to the suction side of the coolant pump via the short-circuit line.

Another exemplary embodiment of the cooling system according to the invention also provides that a mixing valve is located between the main radiator inlet and the coolant outlet, which said mixing valve is interconnected with the suction side of the coolant pump via a short-circuit line. In the case of this exemplary embodiment, it is further provided, however, that the first assembly is connected between the mixing valve and the main radiator inlet. This exemplary embodiment makes it possible for the first assembly to be operated at lower temperatures than the internal combustion engine. In the case of this exemplary embodiment, however, the heat given off by the first assembly is capable of being used to shorten the warm-up period of the internal combustion engine only under certain conditions. This is due to the fact that the coolant flowing through the first assembly must flow through the main radiator before it can flow back into the cooling branch of the internal combustion engine.

It is preferably provided that the first assembly is connected to the pressure side of the coolant pump. By means of this measure it can be ensured that the coolant pump—which is present anyway—produces the required volumetric flow of coolant, so that an additional coolant pump can be eliminated in many cases.

In exemplary embodiments in which at least one second assembly to be cooled is provided, which said assembly is connected with the cooling system via an additional radiator, it is preferably provided that the additional radiator has at least one additional radiator inlet that is connected to the pressure side of the coolant pump. By means of this measure it can be ensured that the coolant flows through the additional radiator with sufficient pressure.

If at least one second assembly to be cooled is provided, which said assembly is connected with the cooling system via the additional radiator, a particularly preferred exemplary embodiment of the cooling system according to the invention provides that the additional radiator has at least one additional radiator outlet that is interconnected via a valve with the second assembly. The volumetric flow of coolant flowing through the second assembly can be influenced by means of this valve. By means of this measure it is possible, for example, to operate the second assembly at markedly lower temperatures than the internal combustion engine and, in fact, within a defined second temperature range. By making such a second defined temperature range possible, advantages can be gained, for example, when the first assembly is formed by a starter-generator, and the second assembly is formed by a power-electronics circuit associated with the starter-generator. In this case, it is possible, for example, to operate the starter-generator itself in a temperature range similar to that of the internal combustion engine, while the associated power-electronics circuit can be operated in a markedly lower temperature range, in order to ensure that the components of the power-electronics circuit are not destroyed or negatively affected by the heat.

In this context in particular, that is, when the second assembly is a power-electronics circuit, a preferred exemplary embodiment of the cooling system according to the invention provides that a temperature sensor is associated with the second assembly. If the second assembly is formed by a power-electronics circuit, it can be provided, for example, that the temperature sensor is integrated in the electronics in the location that is most important in terms of temperature.

If a temperature sensor is provided, it is possible, for example, to activate a valve connected upstream of the second assembly as a function of the temperature detected by the temperature sensor. For this purpose, suitable open-loop and closed-loop controlling systems can be provided. When the second assembly is formed by a power-electronics circuit or any other circuit, it is possible, for example, to integrate the open-loop and closed-loop controlling systems in this circuit. Of course, exemplary embodiments are also possible, for example, in which corresponding open-loop and/or closed-loop controlling system are provided separately of the second assembly.

In the case of the cooling system according to the invention, it can be provided that the delivery rate of the coolant pump depends on the temperature detected by the temperature sensor. Such a dependence of the delivery rate of the coolant pump can be provided for the entire temperature range in question or only for certain temperature ranges. If the temperature sensor is to determine, for example, that the temperature of the second assembly is too high, even though a valve associated with it is completely open, the coolant pump can be activated by means of this measure in such a fashion that its delivery rate is increased.

In the case of the cooling system according to the invention, it can be provided in addition or as an alternative that the delivery rate of the coolant pump is capable of being controlled in open-loop or closed-loop fashion independently of the speed of the internal combustion engine.

In this context in particular, exemplary embodiments are considered in which the coolant pump is an electrical coolant pump.

Preferably, at least one radiator fan known per se is associated with the main radiator and/or the additional radiator. Depending on the spacial arrangement of the main radiator and, if applicable, the additional radiator, a common radiator fan can be provided, or a separate radiator fan can be associated with each of the radiators. In this context, the cooling system according to the invention preferably provides that the temperature detected by the temperature sensor is taken into account in the open-loop or closed-loop control of the radiator fan. Further temperature sensors or other sensors can also be provided, of course, the measurement signals of which are used for the open-loop or closed-loop control of the radiator fan or other components of the cooling system.

The preferred exemplary embodiment of the invention provides, however, that the activation of the valve takes place in the manner of a closed-loop control circuit.

It can further be provided that the second assembly is connected to the suction side of the coolant pump. When the coolant outlet of the second assembly is connected to the suction side of the coolant pump, the coolant flowing out of the second assembly can be routed to the coolant flowing out of the main radiator. This measure is particularly useful when the temperature of the coolant flowing out of the second assembly is still low enough to cool the internal combustion engine.

In the case of all exemplary embodiments of the cooling system according to the invention, it can be provided that the first assembly to be cooled and that is connected in parallel with the internal combustion engine and/or the main radiator is an oil cooler, whereby this does not rule out, of course, that further first assemblies, e.g., a starter-generator, are also connected in parallel.

Independently of whatever is used to specially form the first assembly, it can be provided in the case of the cooling system according to the invention that a valve is associated with the first assembly. This applies in particular for the cases mentioned previously in which the first assembly is formed by a starter-generator and/or an oil cooler.

### SUMMARY OF THE DRAWINGS

The invention is explained in greater detail below with reference to the associated drawings.

FIG. 1 is a cooling system according to the related art,

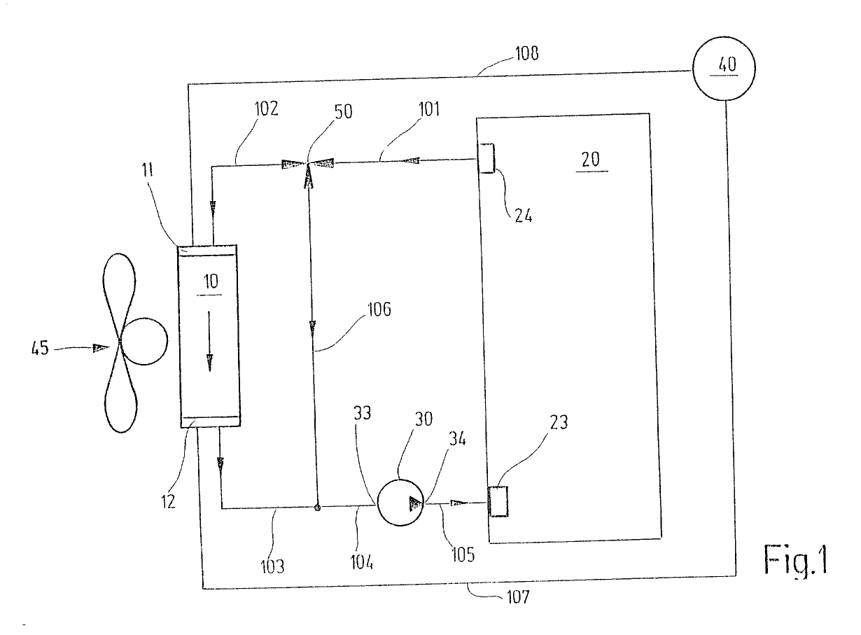

FIG. 2 is a first exemplary embodiment of the cooling system according to the invention in which two first assemblies in the form of a starter-generator and an oil cooler are provided,

FIG. 3 is a second exemplary embodiment of the cooling system according to the invention in which a first assembly in the form of an oil cooler and a second assembly in the form of a power-electronics circuit are provided,

FIG. 4 is a third exemplary embodiment of the cooling system according to the invention in which two first assemblies in the form of an oil cooler and a starter-generator, and a second assembly in the form of a power-electronics circuit are provided, whereby the power-electronics circuit is associated with the starter-generator, and

FIG. 5 is a fourth exemplary embodiment of the cooling system according to the invention in which a first assembly in the form of a starter-generator and a second assembly in the form of a power-electronics circuit are provided, whereby the power-electronics circuit is associated with the starter-generator.

### DESCRIPTION OF THE PREFERRED EMBODIMENTS

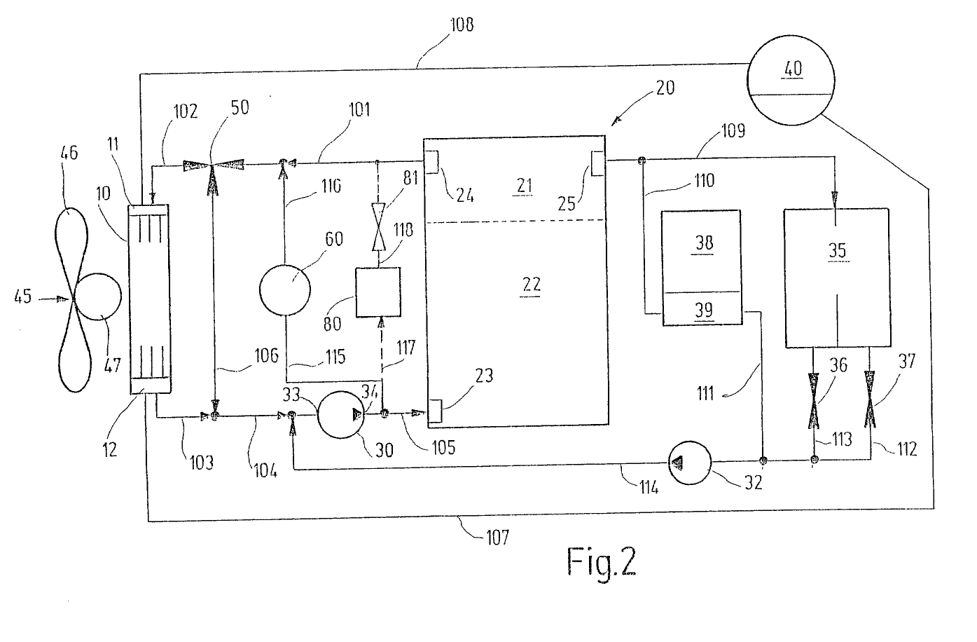

A description of the system components that are at least substantially identical for the exemplary embodiments according to FIGS. 2 through 5 is provided first hereinbelow.

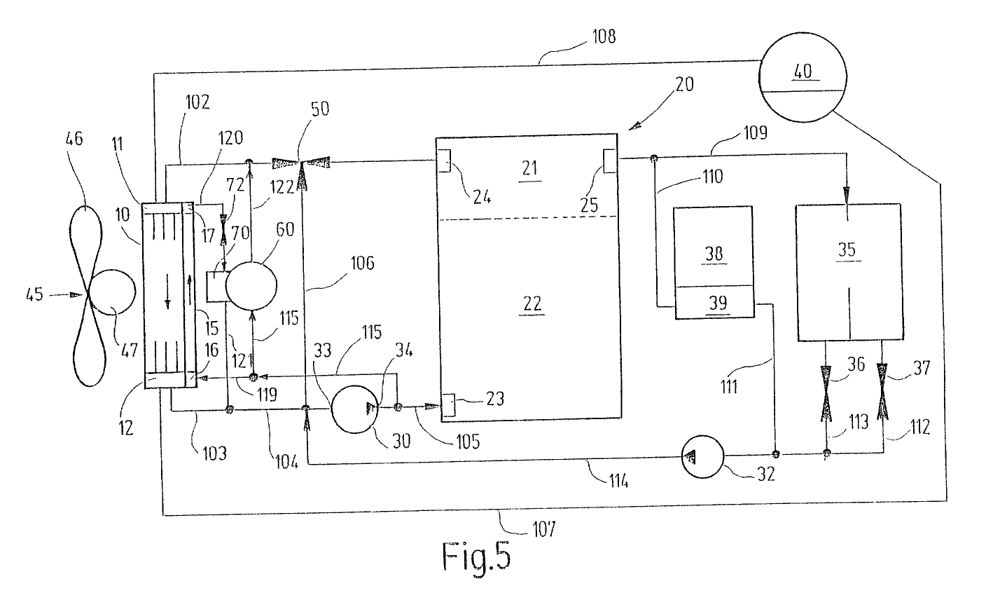

In the case of the exemplary embodiments of the cooling system according to FIGS. 2 through 5, the cooling system comprises a main radiator 10 that has a main radiator inlet 11 and a main radiator outlet 12. Situated adjacent to the main radiator 10 is a radiator fan referred to in entirety with numeral 45. The radiator fan 45 has a ventilator 46 and a radiator fan motor 47 that can start the ventilator 46 rotating. An expansion tank 40—which is of no further interest here—is interconnected via a line section 108 with the main radiator inlet 11 and via a line section 107 with the main radiator outlet 12. The cooling system serves primarily to cool an internal combustion engine 20. The internal combustion engine 20 has a cylinder head 21 and an engine block 22. A coolant inlet 23 of the internal combustion engine 20 is indicated schematically, as is a coolant outlet 24. The coolant outlet 24 of the internal combustion engine is interconnected via a line section 101, a mixing valve 50 and a line section 102 with the main radiator inlet 11. The mixing valve 50 can be formed, for example, by a thermostat valve that is known per se. The coolant inlet 23 of the internal combustion engine 20 is interconnected via a line section 105 with the pressure side 34 of a coolant pump 30. The suction side 33 of the coolant pump 30 is interconnected via a line section 103 and a line section 104 with the main radiator outlet 12. A short-circuit line 106 is associated with the mixing valve 50, whereby the coolant outlet 24 of the internal combustion engine is capable of being interconnected with the coolant outlet 23 via a line section 101, the mixing valve 50, the short-circuit line 106, a line section 104 (except for the exemplary embodiment according to FIG. 5), the coolant pump 30 and a line section 105. The operating temperature of the internal combustion engine 20 can therefore be adjusted or regulated via the mixing valve 50, e.g, in the form of a thermostat valve. During the warm-up period of the internal combustion engine 20, for example, the coolant supply to the main radiator 10 can be blocked entirely or partially by means of the mixing valve 50, so that the operating temperature of the internal combustion engine 20 can be reached more quickly than if the coolant were routed through the main radiator 10. The cylinder head 21 of the internal combustion engine 20 furthermore has a heater connection 25. Coolant that was heated by the internal combustion engine 20 can be drawn from the heater connection 25. The heater connection 25 is interconnected via a line section 109 with a heat exchanger used for heating purposes 35. An air stream is routed through the heat exchanger used for heating purposes 35 by means of suitable measures, which said air stream is provided, for example, to heat the passenger compartment. In order to be able to adjust the temperatures differently for the driver's side and the passenger's side of the passenger compartment, two outlets are associated with the heat exchanger used for heating purposes 35, the first of which has a first heater valve 36, while the second has a second heater valve 37. The coolant flowing through the different sections of the heat exchanger used for heating purposes 35—and, thereby, the temperature for the left and right sides of the vehicle—can be influenced via the first heater valve 36 and the second heater valve 37. The first heater valve 36 and the second heater valve 37 are interconnected via line sections 113 and 112, respectively, with the suction side of a heating-medium pump 32. The pressure side of the heating-medium pump 32 is interconnected via a line section 114 with the suction side 33 of the coolant pump 30. In the case shown, the heating medium and the coolant are formed by one and the same medium. The heater connection 25 of the internal combustion engine 20 is further interconnected via a line section 110 with the heating-medium inlet of a heat exchanger for windshield washing fluid 39. The heat exchanger for windshield washing fluid 39 is provided to heat fluid located in a windshield washing fluid container 38 to prevent ice from forming in the not shown windshield washing fluid system. The outlet of the heat exchanger for windshield washing fluid 39 is also interconnected via a line section 111 with the suction side of the heating-medium pump 32.

According to the exemplary embodiment of FIG. 2, a first assembly 60 in the form of a starter-generator is connected in parallel with the internal combustion engine 20 and the main radiator 10. The coolant supply of the starter-generator 60 is thereby interconnected via a line section 115 with the pressure side 34 of the coolant pump 30. The coolant outlet of the starter-generator 60 is connected via a line section 116 between the mixing valve 50 and the coolant outlet 24 of the internal combustion engine 20. A further first assembly 80 is connected in similar fashion in parallel with the internal combustion engine 20 and the main radiator 10, whereby the coolant inlet of the assembly 80 is interconnected via a line section 117 with the pressure side 34 of the coolant pump 30, while the coolant outlet of the assembly 80 is connected via a line section 118 between the mixing valve 50 and the coolant outlet 24 of the internal combustion engine 20. A valve 81 is thereby provided in the line section 118, with which the coolant supply to the assembly 80 can be adjusted. The fact that two assemblies are provided in the case of this exemplary embodiment is optional, which is why the line sections 117,118 are shown with dashed lines. Due to the fact that the starter-generator 60 and the oil cooler 80 are connected on the pressure side 34 of the coolant pump 30, these assemblies 60, 80 can be cooled without requiring a further coolant pump. The exemplary embodiment of the cooling system according to the invention and according to FIG. 2 has the advantage that, for example, the heat given off by the starter-generator 60 can be used during the warm-up period of the internal combustion engine 20 to warm up the internal combustion engine 20 more quickly by blocking the coolant supply to the main radiator 10 completely or partially by means of the mixing valve 50. The valve 81 associated with the oil cooler 80 makes it possible, for example, for the oil cooler 80 to be operated at higher temperatures than the internal combustion engine 20 and, in fact, by limiting the supply of coolant to the oil cooler 80 via the valve 81 if necessary.

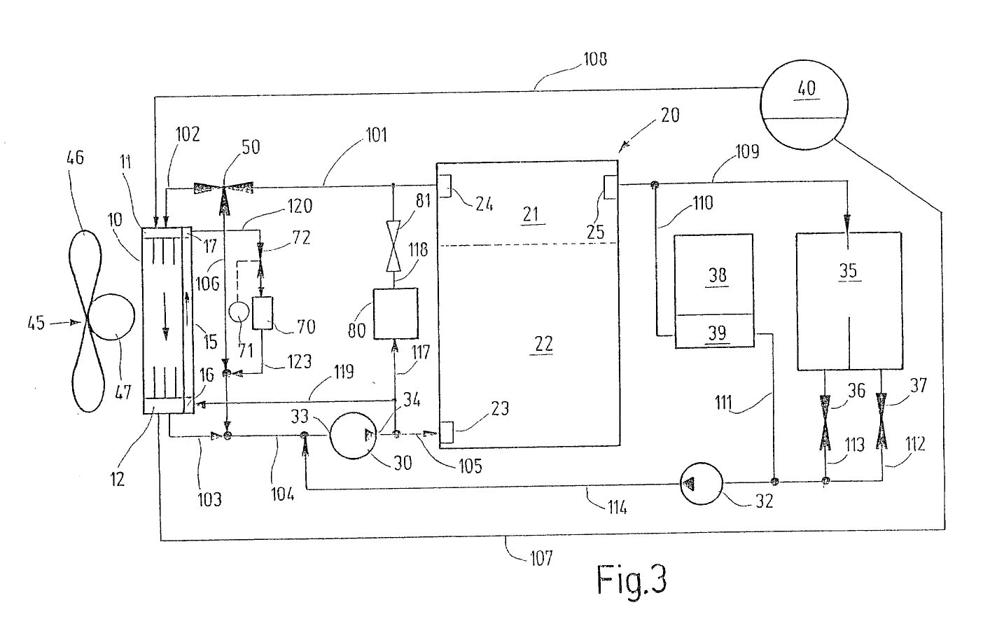

A description of the cooling system according to FIG. 3 follows hereinbelow. With regard for system components that are common to the exemplary embodiments according to FIGS. 2 through 5, reference is made to the corresponding embodiments hereinabove. To avoid repetition, only the relevant differences will be addressed hereinbelow. In the case of the second exemplary embodiment of the cooling system according to the invention and according to FIG. 3, a first assembly 80 to be cooled in the form of an oil cooler is connected in parallel with the internal combustion engine 20 and the main radiator 10. A valve 81 is associated with the oil cooler 80 so that the oil cooler 80 can be operated at a higher temperature, if necessary, than the internal combustion engine 20. The valve 81 is thereby located in a line section 118 that is connected between the mixing valve 50 and the coolant outlet 24 of the internal combustion engine 20. The coolant inlet of the oil cooler 80 is interconnected—as in the exemplary embodiment according to FIG. 2—via a line section 117 with the pressure side of the coolant pump 30. In addition to the first assembly 80 connected in parallel, a second assembly 70 to be cooled is provided in the exemplary embodiment according to FIG. 3, which said assembly is connected via an additional radiator 15 with the cooling system. In the exemplary embodiment shown, the additional radiator 15 is situated in a location that allows the radiator fan 45 to act on the additional radiator 15 as well. The additional radiator 15 has an additional radiator inlet 16 that is interconnected via line sections 119 and 117 with the pressure side 34 of the coolant pump 30. Furthermore, the additional radiator 15 has an additional radiator outlet 17 that is interconnected via a line section 120 with the coolant inlet of the second assembly 70. A valve 72 is provided in the line section 120, via which the coolant routed to the second assembly 70 can be influenced. Furthermore, a temperature sensor 71 is associated with the second assembly 70 that detects the temperature of the second assembly 70 or the temperature of the temperature-sensitive components of the assembly 70. The operating temperature of the second assembly 70 can be adjusted with the aid of the temperature sensor 71 and the valve 72 in the manner of a closed-loop control circuit. Due to the fact that the coolant emerging from the main radiator 10 flows through the additional radiator 15 before it is routed to the second assembly 70, the second assembly 70 can be operated at a markedly lower temperature than the internal combustion engine 20. The coolant emerging from the second assembly 70 typically has a temperature that is still low enough to cool the internal combustion engine 20. For this reason, the coolant outlet of the second assembly 70 is connected via a line section 123 to the short-circuit line 106 and, therefore, the suction side 33 of the coolant pump 30. In the case of the exemplary embodiment according to FIG. 3, the second assembly 70 can be formed, for example, by a circuit, in particular a power-electronics circuit that must be operated at markedly lower temperatures than the internal combustion engine 20.

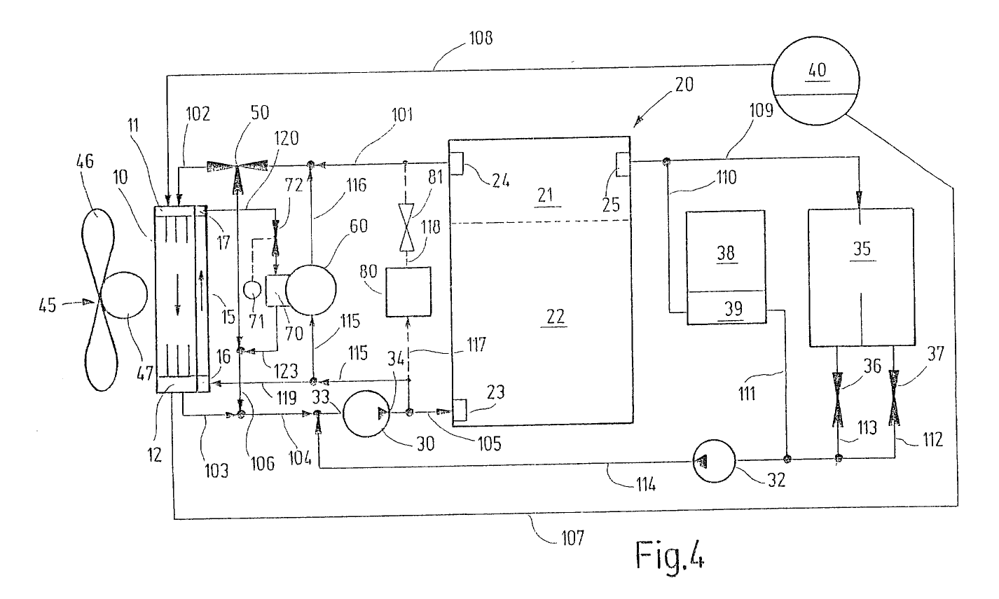

A description of the cooling system according to FIG. 4 follows hereinbelow. With regard for system components that are common to the exemplary embodiments according to FIGS. 2 through 5, reference is made to the corresponding embodiments hereinabove. To avoid repetition, only the relevant differences will be addressed hereinbelow. FIG. 4 shows a third exemplary embodiment of the cooling system according to the invention. In the case of this exemplary embodiment, a first assembly 80 to be cooled in the form of an oil cooler is connected in parallel with the internal combustion engine 20. For this purpose, the coolant outlet of the oil cooler 80 is connected via a line section 118 between the coolant outlet 24 of the internal combustion engine 20 and the mixing valve 50. A valve 81 is again associated with the line section 118, with which the operating temperature of the oil cooler 80 can be adjusted. The coolant inlet of the oil cooler 80 is interconnected via a line section 117 with the pressure side 34 of the coolant pump 30. Since the oil cooler 80 is provided as an option, the line sections 117 and 118 are shown once more in dashed form. In addition to the oil cooler 80, a further first assembly 60 is provided in the form of a starter-generator. The starter-generator 60 is also connected in parallel with the internal combustion engine 20. The coolant inlet of the starter-generator 60 is interconnected via a line section 115 with the pressure side 34 of the coolant pump 30. The coolant outlet of the starter-generator is connected via a line section 116 between the mixing valve 50 and the coolant outlet 24 of the internal combustion engine 20. The coolant inlet of the starter-generator 60 is interconnected via a line section 115 with the pressure side 34 of the coolant pump 30. The coolant outlet of the starter-generator 60 is connected via a line section 116 between the mixing valve 50 and the coolant outlet 24 of the internal combustion engine 20. In the case shown, the starter-generator 60 is operated in approximately the same temperature range as the internal combustion engine 20, because a valve associated especially with the starter-generator 60 is not provided in the line section 116 or in the line section 115. In particular, when the starter-generator 60 is to be operated at higher temperatures than the internal combustion engine, at least one such valve can be provided in the line section 116 and/or in the line section 115. The starter-generator 60 has a power-electronics circuit 70 that itself must be operated at markedly lower temperatures than the starter-generator 60. For this reason, an additional radiator 15 is provided in the case of the exemplary embodiment according to FIG. 4, which said radiator is located adjacent to the main radiator 10 so that the radiator fan 45 can also act on the additional radiator 15. The additional radiator 15 has an additional radiator inlet 16 that is interconnected via a line section 119 and a line section 115 with the pressure side 34 of the coolant pump 30. Furthermore, the additional radiator 15 has an additional radiator outlet 17 that is interconnected via a line section 120 with the coolant inlet of the power-electronics circuit 70 that, in the case of this exemplary embodiment, forms a second assembly to be cooled that is connected via the additional radiator 15 to the cooling system. A valve 71 is provided in the line section 120 in order to adjust the amount of coolant used to cool the power-electronics circuit 70 and, moreover, to set the operating temperature of the power-electronics circuit 70. A temperature sensor is furthermore associated with the power-electronics circuit 70, which said temperature sensor is preferably located in the most heat-sensitive region of the power-electronics circuit 70. The power-electronics circuit 70 can have circuit components that are provided to evaluate the temperature or a corresponding signal detected by the temperature sensor 71. A particularly effective arrangement results when the valve 72 is activated via corresponding circuit components in the fashion of a closed-loop control circuit as a function of the temperature detected by the temperature sensor 71. The coolant outlet of the power-electronics circuit 70 is interconnected via a line section 123 with the short-circuit line 106 and, therefore, via a further line section 104 with the suction side 33 of the coolant pump 30. The exemplary embodiment according to FIG. 4 makes it possible for the starter-generator 60 itself to be operated at a higher temperature level than the power-electronics circuit 70 associated with it. A further coolant pump is not required for this purpose.

A description of the cooling system according to FIG. 5 follows hereinbelow. With regard for system components that are common to the exemplary embodiments according to FIGS. 2 through 5, reference is made to the corresponding embodiments hereinabove. To avoid repetition, only the relevant differences will be addressed hereinbelow. FIG. 5 shows a fourth exemplary embodiment of the cooling system according to the invention. In the case of this exemplary embodiment, a starter-generator 60 forms a first assembly to be cooled. In the case of the exemplary embodiment according to FIG. 5, the coolant inlet of the starter-generator 60 is connected via a line section 122 between the main radiator inlet 11 and the mixing valve 50. The coolant inlet of the starter-generator 60 is interconnected via a line section 115 with the pressure side 34 of the coolant pump 30. In the case of this connection variant of the first assembly or the starter-generator 60, the starter-generator 60 can be operated at lower temperatures than the internal combustion engine 20. For this purpose, the flow of coolant through the internal combustion engine 20 can be restricted, even in the case of a high delivery rate of the coolant pump 30, by means of the valve 50, for example, in order to raise the operating temperature of the internal combustion engine 20. However, the heat given off by the starter-generator 6 in the case of this connection variant is usable for shortening the warm-up period of the internal combustion engine 20 only under certain conditions, because the coolant emerging from the starter-generator 60 must flow through the main radiator 10 in order to flow back to the cooling branch of the internal combustion engine 20. A power-electronics circuit 70 is associated, again, with the starter-generator 60, which said power-electronics circuit forms a second assembly that is connected via an additional radiator 15 with the cooling system. The additional radiator 15, once again, is located adjacent to the main radiator 10, so that a single radiator fan 45 can act on the main radiator 10 as well as the additional radiator 15. The additional radiator 15 has an additional radiator inlet 16 that is interconnected via line sections 116,115 with the pressure side 34 of the coolant pump 30. Furthermore, the additional radiator 15 has an additional radiator outlet 17 that is interconnected via a line section 120 with a coolant inlet of the power-electronics circuit 70. A valve 72 is provided in the line section 120, via which the operating temperature of the power-electronics circuit 70 can be adjusted. Suitable open-loop and closed-loop controlling systems can be provided for this purpose. The coolant outlet of the power-electronics circuit 70 is interconnected via a line section 121 and a line section 104 with the suction side 33 of the coolant pump 30. As a result of this, the coolant warmed by the power-electronics circuit 70 is routed to the cooling branch for the internal combustion engine 20.

The preceding description of the exemplary embodiments according to the present invention is intended for illustrative purposes only and not for purposes of limiting the invention. Various changes and modifications are possible within the framework of the invention without leaving the scope of the invention or its equivalents.

What is claimed is:

1. A cooling system for a motor vehicle having at least one coolant pump (30) that is provided in order to circulate coolant in the cooling system, and having a main radiator (10) that has at least one main radiator inlet (11) and at least one main radiator outlet (12), whereby the main radiator inlet (11) is interconnected at least part of the time with a coolant outlet (24) of an internal combustion engine (20) to be cooled, while the main radiator outlet (12) is interconnected with a coolant inlet (23) of the internal combustion engine (20), wherein at least a first assembly (60, 80) to be cooled is connected in parallel with the internal combustion engine and/or the main radiator (10).

2. The cooling system according to claim 1,
wherein at least one second assembly (70) to be cooled is provided that is connected via an additional radiator (15) with the cooling system.

3. The cooling system according to one of the preceding claims,
wherein the first assembly (60) is an electrical machine.

4. The cooling system according to one of the preceding claims,
wherein the second assembly (70) is a circuit (70).

5. The cooling system according to one of the preceding claims,
wherein the first assembly (60) is a starter-generator, and
wherein the second assembly (70) is a power-electronics circuit associated with the starter-generator.

6. The cooling system according to one of the preceding claims,
wherein a mixing valve (50) is provided between the main radiator inlet (11) and the coolant outlet (24), which said mixing valve is interconnected via a short-circuit line (106) with the suction side (33) of the coolant pump (30), and
wherein the first assembly (60, 80) is connected between the mixing valve (50) and the coolant outlet (24).

7. The cooling system according to one of the preceding claims,
wherein a mixing valve (50) is provided between the main radiator inlet (11) and the coolant outlet (24), which said mixing valve is interconnected via a short-circuit line (106) with the suction side (33) of the coolant pump (30), and
wherein the first assembly (60, 80) is connected between the mixing valve (50) and the main radiator inlet (11).

8. The cooling system according to one of the preceding claims,
wherein the first assembly is connected to the pressure side (34) of the coolant pump (30).

9. The cooling system according to one of the preceding claims,
wherein the additional radiator (15) has at least one additional radiator inlet (16) that is connected to the pressure side (34) of the coolant pump (30).

10. The cooling system according to one of the preceding claims,
wherein the additional radiator (15) has at least one additional radiator outlet (17) that is connected with the second assembly (70).

11. The cooling system according to one of the preceding claims,
wherein the additional radiator outlet (17) is connected via a valve (72) with the second assembly (70).

12. The cooling system according to one of the preceding claims,
wherein a temperature sensor (71) is associated with the second assembly (70).

13. The cooling system according to one of the preceding claims,
wherein the valve (72) is activated depending on the temperature detected by the temperature sensor (71).

14. The cooling system according to one of the preceding claims,
wherein the delivery rate of the coolant pump (30) depends on the temperature detected by the temperature sensor (71).

15. The cooling system according to one of the preceding claims,
wherein the delivery rate of the coolant pump (30) is capable of being controlled in open-loop or closed-loop fashion independently of the speed of the internal combustion engine.

16. The cooling system according to one of the preceding claims,
wherein the coolant pump (30) is an electrical coolant pump.

17. The cooling system according to one of the preceding claims,
wherein at least one radiator fan (45) is associated with the main radiator (10) and/or the additional radiator (15), and
wherein the temperature detected by the temperature sensor (71) is taken into account in the open-loop control or closed-loop control of the radiator fan (45).

18. The cooling system according to one of the preceding claims,
wherein the activation of the valve (72) takes place in the fashion of a closed-loop control circuit.

19. The cooling system according to one of the preceding claims,
wherein the second assembly (70) is connected to the suction side (33) of the coolant pump (30).

20. The cooling system according to one of the preceding claims,
wherein the first assembly (80) to be cooled that is connected in parallel with the internal combustion engine and/or the main radiator (10) is an oil cooler.

21. The cooling system according to one of the preceding claims,
wherein a valve (81) is associated with the first assembly (60, 80).
